(19) United States
(12) Patent Application Publication
(10) Pub. No.: US 2025/0109620 A1
(43) Pub. Date: Apr. 3, 2025

(54) MECHANISM CAPABLE OF FIXING DOOR AT MULTIPLE ANGLES, AND DOOR LOCK

(71) Applicant: Shenzhen Duokui Technology Co., Ltd., Shenzhen (CN)

(72) Inventor: Jiasen Chen, Shantou (CN)

(21) Appl. No.: 18/981,476

(22) Filed: Dec. 14, 2024

(30) Foreign Application Priority Data
Mar. 13, 2023 (CN) 202420487838.7

(51) Int. Cl. E05C 17/04

(52) U.S. Cl. CPC E05C 17/04

(57) ABSTRACT

The present disclosure discloses a mechanism capable of fixing a door at multiple angles and a door lock. The mechanism includes at least a latch bolt barrier plate and a latch bolt barrier plate rotating and fixing device. The latch bolt barrier plate is provided with a plurality of through holes matching the shape of a latch bolt. The latch bolt barrier plate rotating and fixing device is provided on a wall away from a door hinge, and when the latch bolt barrier plate is rotated to a preset angle, the latch bolt barrier plate rotating and fixing device fixes the latch bolt barrier plate.

### TECHNICAL FIELD

The present disclosure relates to the field of locks, and in particular to a mechanism capable of fixing a door at multiple angles, and a door lock.

### BACKGROUND

The current door locks include mainly two parts: a retractable latch bolt mounted on a door and a strike plate mounted on a doorjamb. When the door is closed, the latch bolt is placed into the strike plate, providing a limiting action to complete the closing of the door.

The door using the above-mentioned door lock is stable only when closed. When the door is open, it may rotate freely under the action of external forces (such as gusts of wind), or even close violently or hit the wall with a loud noise.

In order to solve this problem, magnetic devices are correspondingly disposed on the back of the door and the wall away from the strike plate, and lock the door to the wall when the door is opened. This solves the problem of the door turning freely, but at the same time brings another problem: In the solution, after being opened, the door can only be left wide open because the opening angle of the door cannot be adjusted.

When a room only needs to be opened at a small angle (such as to only allow for space for pets, ventilation, and privacy), neither of the above solutions can meet the requirements.

### SUMMARY

An objective of the present disclosure is to provide a mechanism capable of fixing a door at multiple angles to overcome the drawbacks and shortcomings of the prior art.

An objective of the present disclosure is to provide a door lock.

The objective of the present disclosure is achieved by using the following technical solution:

A mechanism capable of fixing a door at multiple angles includes a latch bolt barrier plate and a latch bolt barrier plate rotating and fixing device, where the latch bolt barrier plate is provided with a plurality of through holes matching the shape of a latch bolt; and the latch bolt barrier plate rotating and fixing device is provided on a wall away from a door hinge, and when the latch bolt barrier plate is rotated to a preset angle, the latch bolt barrier plate rotating and fixing device fixes the latch bolt barrier plate.

A mechanism capable of fixing a door at multiple angles includes a latch bolt fixing plate, a latch bolt barrier plate, and a latch bolt barrier plate rotating and fixing device, where the front of the latch bolt fixing plate is provided with a hollow slot for receiving a latch bolt, and the latch bolt barrier plate rotating and fixing device is provided on a side of the latch bolt fixing plate; the latch bolt barrier plate rotating and fixing device is provided on a wall away from a door hinge, and when the latch bolt barrier plate is rotated to a preset angle, the latch bolt barrier plate rotating and fixing device fixes the latch bolt barrier plate; and the latch bolt barrier plate is provided with a plurality of through holes matching the shape of the latch bolt.

The latch bolt barrier plate rotating and fixing device includes a housing, a limiting switch, and a swing arm, where the swing arm has one end connected to the latch bolt barrier plate and the other end rotating about a swing arm shaft provided in the housing; a limiting block is provided on a rotation path of the swing arm; a body of the limiting switch is provided with a limiting bar, the bottom of the limiting bar being in contact with a spring; the swing arm is provided with a notch adapted to the shape of the limiting bar; and in a state where the notch is not engaged with the limiting bar, the swing arm provides downward pressure for the limiting bar.

The latch bolt barrier plate rotating and fixing device includes a housing, a limiting switch, and a swing arm, where the swing arm has one end connected to the latch bolt barrier plate and the other end rotating about a swing arm shaft provided in the housing; a limiting block is provided on a rotation path of the swing arm; a limiting switch uses a self-locking switch, and a body of the limiting switch is provided with a limiting bar; the swing arm is provided with a notch adapted to the shape of the limiting bar; and in a state where the notch is not engaged with the limiting bar, the swing arm does not provide downward pressure for the limiting bar either.

The latch bolt barrier plate includes a shorter first arc-shaped barrier plate and a longer second arc-shaped barrier plate, the second arc-shaped barrier plate is provided with a plurality of through holes, arc-shaped openings of the second arc-shaped barrier plate and the rotation of the door are on the same side of the latch bolt barrier plate, and an arc-shaped opening of the first arc-shaped barrier plate faces the another, opposite side of the latch bolt barrier plate.

The arc of the second arc-shaped barrier plate has a corresponding radius less than or equal to a width of the door.

The latch bolt barrier plate is made of an elastic material.

The other objective of the present disclosure is achieved by using the following technical solution:

A door lock includes the above-described mechanism capable of fixing a door at multiple angles and a matching latch bolt.

Compared with the prior art, the present disclosure has the following advantages and beneficial effects:
1. According to the mechanism capable of fixing a door at multiple angles of the present disclosure, there is only a need to mount the latch bolt barrier plate and the latch bolt barrier plate rotating and fixing device beside the original strike plate. Alternatively, the original strike plate is replaced with the latch bolt fixing plate, and then the latch bolt barrier plate rotating and fixing device and the latch bolt barrier plate that are connected to the latch bolt fixing plate are added. Then the latch bolt is fixed in different through holes under the limiting action of the plurality of through holes provided in the latch bolt barrier plate, such that the door is fixed at different opening angles, leaving door gaps of different widths for the door. The present disclosure has a simple overall structure and low cost, making it easy to be widely used.
2. According to the mechanism capable of fixing a door at multiple angles of the present disclosure, when the door is closed or in other cases that do not require the latch bolt barrier plate to operate, the latch bolt barrier plate can be folded close to or even attach onto the wall, without taking up extra space and allowing for beautiful appearance.

### BRIEF DESCRIPTION OF DRAWINGS

FIG. 1 is an exploded view of a mechanism capable of fixing a door at multiple angles according to the present disclosure.

FIG. 2 is an exploded view of a latch bolt barrier plate rotating and fixing device according to the present disclosure.

FIG. 3 is a diagram illustrating a first operating state of a latch bolt barrier plate rotating and fixing device according to the present disclosure.

FIG. 4 is a diagram illustrating a second operating state of a latch bolt barrier plate rotating and fixing device according to the present disclosure.

FIG. 5 is a diagram illustrating a third operating state of a latch bolt barrier plate rotating and fixing device according to the present disclosure.

FIG. 6 is a first perspective view of a mechanism capable of fixing a door at multiple angles according to the present disclosure.

FIG. 7 is a second perspective view of a mechanism capable of fixing a door at multiple angles according to the present disclosure.

FIG. 8 is a diagram illustrating an operating state of a mechanism capable of fixing a door at multiple angles according to the present disclosure.

FIG. 9 is a partial enlarged view of FIG. 8.

FIG. 10 is a top view of FIG. 8.

FIG. 11 is a diagram illustrating a structure of a latch bolt barrier plate being folded according to the present disclosure.

The reference numerals are as follows:

1: latch bolt fixing plate; 2: latch bolt barrier plate; 3: hollow slot: 4: latch bolt; 5: door; 6: through hole; 7: housing; 8: swing arm; 9: swing arm shaft; 10: limiting block; 11: body of limiting switch; 12: limiting bar; 13: notch; 14: first arc-shaped barrier plate; 15: second arc-shaped barrier plate; 16: spring.

### DETAILED DESCRIPTION OF EMBODIMENTS

The present disclosure will be described in further detail below with reference to the embodiments and drawings, but the implementations of the present disclosure are not limited thereto.

### Embodiment 1

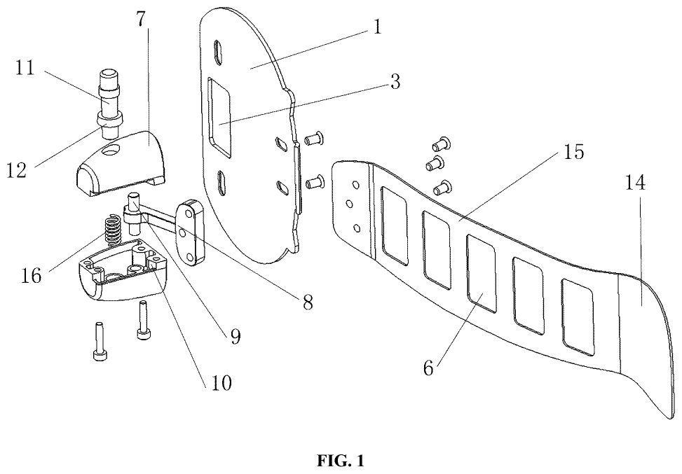

As shown in FIG. 1 to FIG. 11, a mechanism capable of fixing a door at multiple angles includes a latch bolt fixing plate 1, a latch bolt barrier plate 2, and a latch bolt barrier plate rotating and fixing device. The front of the latch bolt fixing plate 1 is provided with a hollow slot 3 for receiving a latch bolt 4, and the latch bolt barrier plate rotating and fixing device is provided on a side of the latch bolt fixing plate 1. The latch bolt barrier plate rotating and fixing device is provided on a wall away from a door hinge, and when the latch bolt barrier plate 2 is rotated to a preset angle, the latch bolt barrier plate rotating and fixing device fixes the latch bolt barrier plate 2. The latch bolt barrier plate 2 is provided with a plurality of through holes 6 matching the shape of the latch bolt 4.

In this embodiment, the latch bolt fixing plate 1 and the latch bolt barrier plate rotating and fixing device are of split-type design, and the two are fastened by two screws and threaded holes. In actual production, the latch bolt fixing plate 1 and a housing 7 of the latch bolt barrier plate rotating and fixing device may also be integrally formed.

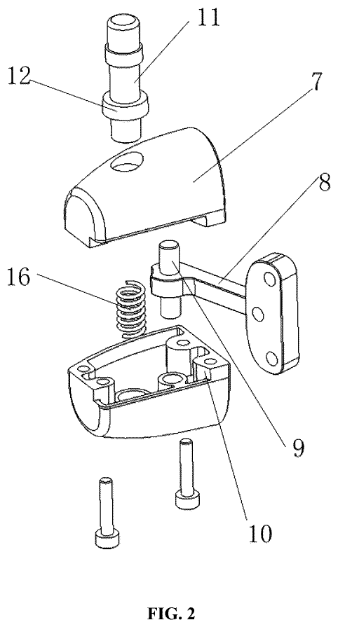

As shown in FIG. 2, the latch bolt barrier plate rotating and fixing device includes a housing 7, a limiting switch, and a swing arm 8. The swing arm 8 has one end connected to the latch bolt barrier plate 2 and the other end rotating about a swing arm shaft 9 provided in the housing 7. A limiting block 10 is provided on a rotation path of the swing arm 8. A body 11 of the limiting switch is provided with a limiting bar 12, the bottom of the limiting bar 12 being in contact with a spring 16. The swing arm 8 is provided with a notch 13 adapted to the shape of the limiting bar 12. In a state where the notch 13 is not engaged with the limiting bar 12, the swing arm 8 provides downward pressure for the limiting bar 12.

In this embodiment, the limiting switch may also use a self-locking switch. In this case, the limiting bar 12 of the limiting switch does not require the swing arm 8 to provide downward pressure during operation. The limiting switch using the self-locking switch can independently complete pressing and resetting.

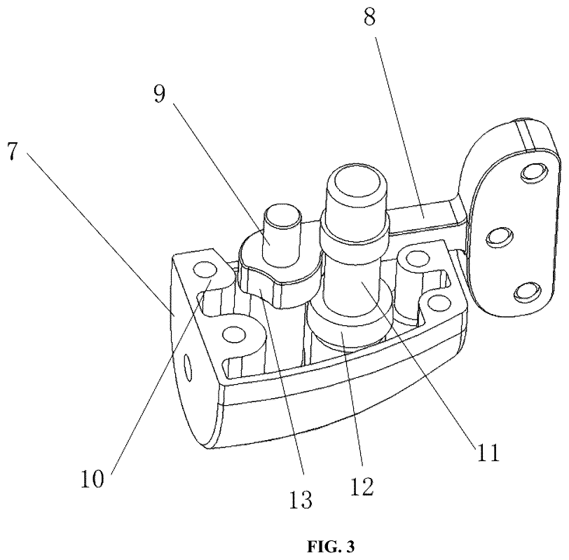

As shown in FIG. 3 and FIG. 11, the swing arm 8 is folded close to the wall, and the body 11 of the limiting switch is in a pressed state.

As shown in FIG. 4, the swing arm 8 is in the process of rotation, and the body 11 of the limiting switch is in a pressed state.

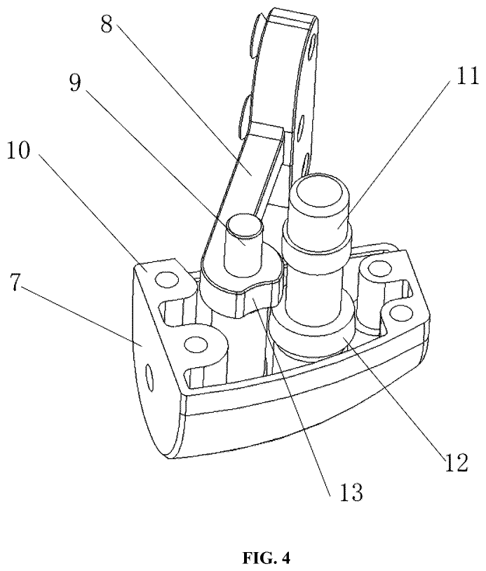

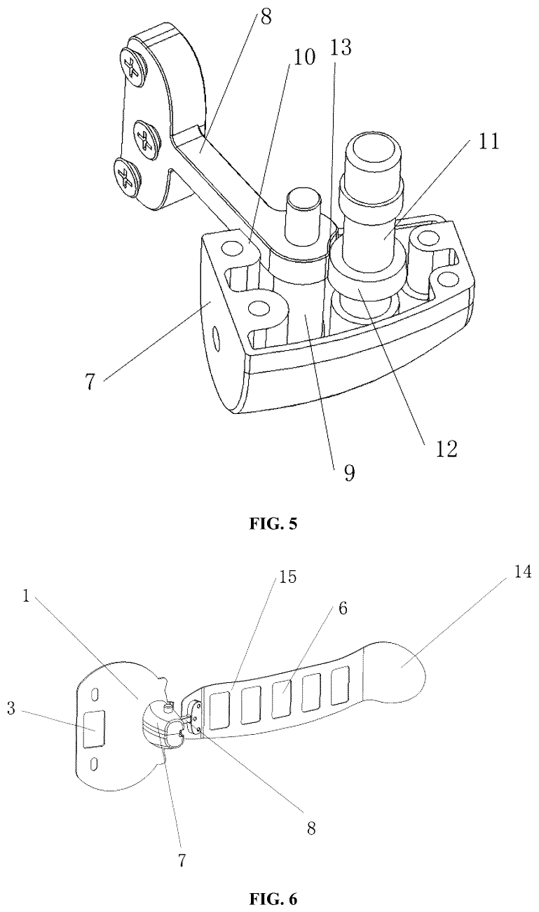

As shown in FIG. 5, the swing arm 8 is rotated to a preset position and stopped by the limiting block 10, the body 11 of the limiting switch pops up, and the rising limiting bar 12 is just stuck onto the notch 13.

In this embodiment, the limiting bar 12 is provided at a lower position of the body 11 of the limiting switch. When the limiting switch is pressed, the limiting bar 12 sinks, and the swing arm 8 can be rotated freely until it is stopped by the limiting block 10. Then the limiting switch pops up, and the limiting bar 12 rises and is just engaged with the notch 13 of the swing arm 8. The swing arm 8 is stopped by both the limiting block 10 and the limiting bar 12, such that the swing arm 8 is fixed, and the latch bolt barrier plate 2 fastened to the swing arm 8 is also fixed. After the latch bolt 4 is fixed into a through hole 6 of the latch bolt barrier plate 2, the opening angle of the door 5 remains fixed. Similarly, in actual applications, it is also possible to provide the limiting bar 12 at a middle or other position of the body 11 of the limiting switch, as long as the notch 13 is aligned with the limiting bar 12 when the spring is reset, that is, when the limiting switch automatically pops up.

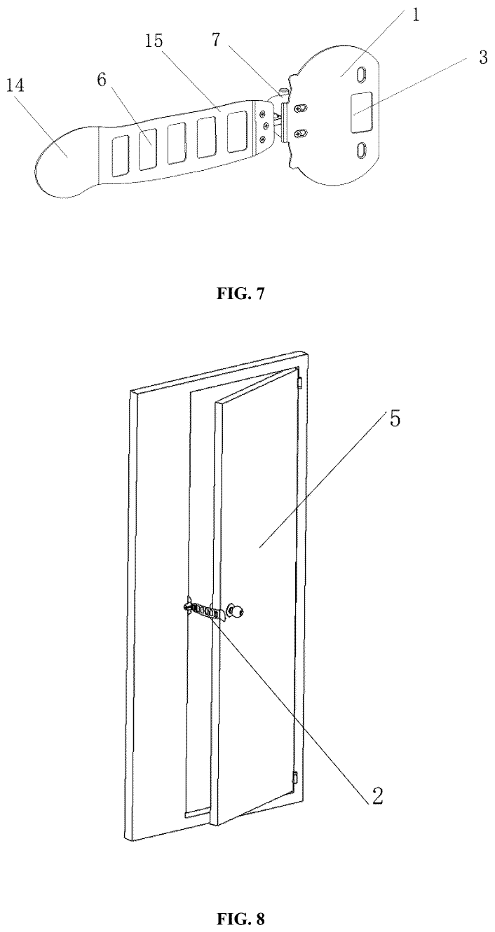

As shown in FIG. 6 and FIG. 7, the latch bolt barrier plate 2 includes a shorter first arc-shaped barrier plate 14 and a longer second arc-shaped barrier plate 15, the second arc-shaped barrier plate 15 is provided with a plurality of through holes 6, arc-shaped openings of the second arc-shaped barrier plate 15 and the rotation of the door 5 are on the same side of the latch bolt barrier plate 2, and an arc-shaped opening of the first arc-shaped barrier plate 14 faces the another, opposite side of the latch bolt barrier plate 2.

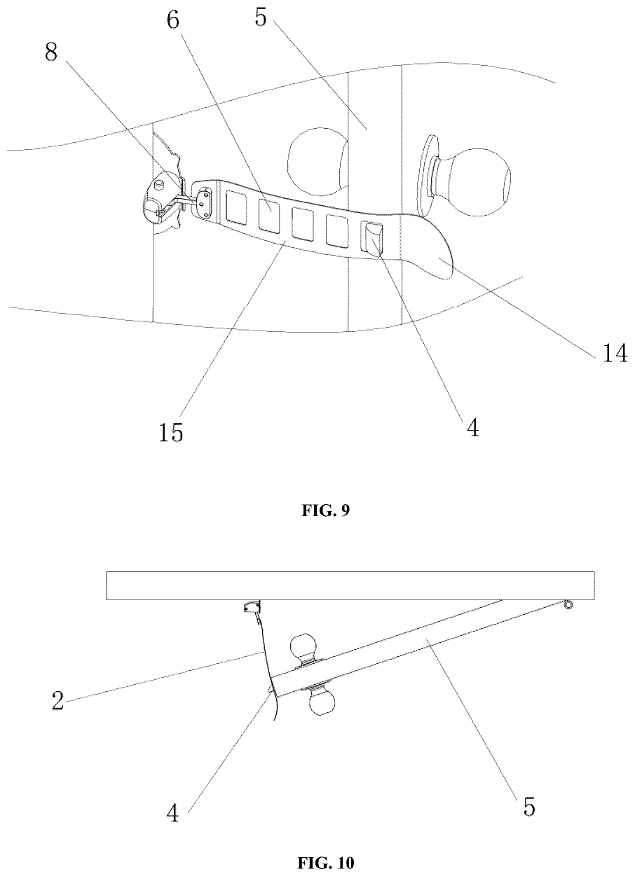

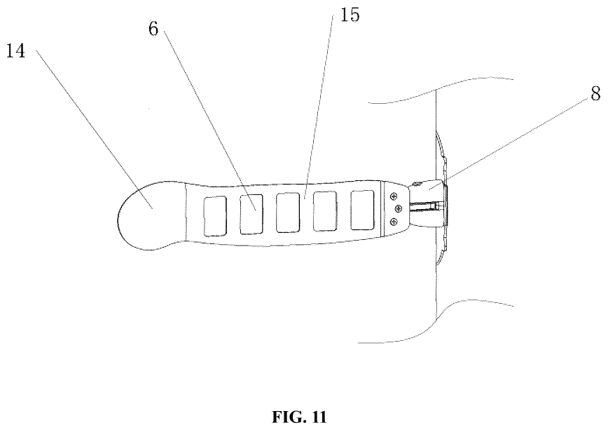

As shown in FIG. 8, FIG. 9, and FIG. 10, the arc-shaped opening direction of the first arc-shaped barrier plate 14 is conducive to guiding the door 5 to rotate while being in contact with the door, and when in contact with the first arc-shaped barrier plate 14, the door 5 can continue to move along the first arc without being blocked.

The arc of the second arc-shaped barrier plate 15 has a corresponding radius less than or equal to a width of the door 5.

According to the above design, the second arc-shaped barrier plate 15 can always fit the side of the door 5, and at the same time, the hole position of the through hole 6 of the second arc-shaped barrier plate 15 can more closely fit the latch bolt 4, thereby achieving a better effect of fixing the door 5.

The latch bolt barrier plate 2 is made of an elastic material.

According to the above-described mechanism capable of fixing a door at multiple angles, the original latch bolt 4 does not need to be changed, and there is only a need to replace the original strike plate with the latch bolt fixing plate 1, and then add the latch bolt barrier plate 2 and the latch bolt barrier plate rotating and fixing device that are connected to the latch bolt fixing plate 1.

It is also possible to provide a door lock, including the mechanism capable of fixing a door at multiple angles described in Embodiment 1, and a matching latch bolt 4. In this way, the material and color of the latch bolt 4 can be consistent with the mechanism capable of fixing a door at multiple angles, which is more beautiful.

### Embodiment 2

Except for the following content, the rest is the same as Embodiment 1:

A mechanism capable of fixing a door at multiple angles includes a latch bolt barrier plate and a latch bolt barrier plate rotating and fixing device.

The latch bolt barrier plate is provided with a plurality of through holes matching the shape of a latch bolt. The latch bolt barrier plate rotating and fixing device is provided on a wall away from a door hinge, and when the latch bolt barrier plate is rotated to a preset angle, the latch bolt barrier plate rotating and fixing device fixes the latch bolt barrier plate.

That is, the mechanism capable of fixing a door at multiple angles in Embodiment 2 does not have a latch bolt fixing plate, and directly reuses the original strike plate.

Similarly, it is also possible to provide a door lock, including the mechanism capable of fixing a door at multiple angles described in Embodiment 2, and a matching latch bolt.

The above-mentioned embodiments are preferred implementations of the present disclosure. However, the implementations of the present disclosure are not limited to the above-mentioned embodiments, and any other changes, modifications, substitutions, combinations, and simplifications made without departing from the spirit and principle of the present disclosure shall all be equivalent permutations and all be included in the scope of protection of the present disclosure.

What is claimed is:

1. A mechanism capable of fixing a door at multiple angles, comprising a latch bolt barrier plate and a latch bolt barrier plate rotating and fixing device, wherein the latch bolt barrier plate is provided with a plurality of through holes matching the shape of a latch bolt; and the latch bolt barrier plate rotating and fixing device is provided on a wall away from a door hinge, and when the latch bolt barrier plate is rotated to a preset angle, the latch bolt barrier plate rotating and fixing device fixes the latch bolt barrier plate.

2. A mechanism capable of fixing a door at multiple angles, comprising a latch bolt fixing plate, a latch bolt barrier plate, and a latch bolt barrier plate rotating and fixing device, wherein the front of the latch bolt fixing plate is provided with a hollow slot for receiving a latch bolt, and the latch bolt barrier plate rotating and fixing device is provided on a side of the latch bolt fixing plate; the latch bolt barrier plate rotating and fixing device is provided on a wall away from a door hinge, and when the latch bolt barrier plate is rotated to a preset angle, the latch bolt barrier plate rotating and fixing device fixes the latch bolt barrier plate; and the latch bolt barrier plate is provided with a plurality of through holes matching the shape of the latch bolt.

3. The mechanism capable of fixing a door at multiple angles according to claim 1, wherein the latch bolt barrier plate rotating and fixing device comprises a housing, a limiting switch, and a swing arm, wherein the swing arm has one end connected to the latch bolt barrier plate and the other end rotating about a swing arm shaft provided in the housing; a limiting block is provided on a rotation path of the swing arm; a body of the limiting switch is provided with a limiting bar, the bottom of the limiting bar being in contact with a spring; the swing arm is provided with a notch adapted to the shape of the limiting bar; and in a state where the notch is not engaged with the limiting bar, the swing arm provides downward pressure for the limiting bar.

4. The mechanism capable of fixing a door at multiple angles according to claim 1, wherein the latch bolt barrier plate rotating and fixing device comprises a housing, a limiting switch, and a swing arm, wherein the swing arm has one end connected to the latch bolt barrier plate and the other end rotating about a swing arm shaft provided in the housing; a limiting block is provided on a rotation path of the swing arm; a limiting switch uses a self-locking switch, and a body of the limiting switch is provided with a limiting bar; the swing arm is provided with a notch adapted to the shape of the limiting bar; and in a state where the notch is not engaged with the limiting bar, the swing arm does not provide downward pressure for the limiting bar either.

5. The mechanism capable of fixing a door at multiple angles according to claim 1, wherein the latch bolt barrier plate comprises a shorter first arc-shaped barrier plate and a longer second arc-shaped barrier plate, the second arc-shaped barrier plate is provided with a plurality of through holes, arc-shaped openings of the second arc-shaped barrier plate and the rotation of the door are on the same side of the latch bolt barrier plate, and an arc-shaped opening of the first arc-shaped barrier plate faces the another, opposite side of the latch bolt barrier plate.

6. The mechanism capable of fixing a door at multiple angles according to claim 5, wherein the arc of the second arc-shaped barrier plate has a corresponding radius less than or equal to a width of the door.

7. The mechanism capable of fixing a door at multiple angles according to claim 1, wherein the latch bolt barrier plate is made of an elastic material.

8. A door lock, comprising the mechanism capable of fixing a door at multiple angles according to claim 1, and a matching latch bolt.

9. The mechanism capable of fixing a door at multiple angles according to claim 2, wherein the latch bolt barrier plate rotating and fixing device comprises a housing, a limiting switch, and a swing arm, wherein the swing arm has one end connected to the latch bolt barrier plate and the other end rotating about a swing arm shaft provided in the housing; a limiting block is provided on a rotation path of the swing arm; a body of the limiting switch is provided with a limiting bar, the bottom of the limiting bar being in contact with a spring; the swing arm is provided with a notch adapted to the shape of the limiting bar; and in a state where the notch is not engaged with the limiting bar, the swing arm provides downward pressure for the limiting bar.

10. The mechanism capable of fixing a door at multiple angles according to claim 2, wherein the latch bolt barrier plate rotating and fixing device comprises a housing, a limiting switch, and a swing arm, wherein the swing arm has one end connected to the latch bolt barrier plate and the other end rotating about a swing arm shaft provided in the housing; a limiting block is provided on a rotation path of the swing arm; a limiting switch uses a self-locking switch, and a body of the limiting switch is provided with a limiting bar; the swing arm is provided with a notch adapted to the shape of the limiting bar; and in a state where the notch is not engaged with the limiting bar, the swing arm does not provide downward pressure for the limiting bar either.

11. The mechanism capable of fixing a door at multiple angles according to claim 2, wherein the latch bolt barrier plate comprises a shorter first arc-shaped barrier plate and a longer second arc-shaped barrier plate, the second arc-shaped barrier plate is provided with a plurality of through holes, arc-shaped openings of the second arc-shaped barrier plate and the rotation of the door are on the same side of the latch bolt barrier plate, and an arc-shaped opening of the first arc-shaped barrier plate faces the another, opposite side of the latch bolt barrier plate.

12. The mechanism capable of fixing a door at multiple angles according to claim 2, wherein the latch bolt barrier plate is made of an elastic material.

13. A door lock, comprising the mechanism capable of fixing a door at multiple angles according to claim 2, and a matching latch bolt.
